(19) United States
(12) Patent Application Publication
(10) Pub. No.: US 2006/0228194 A1
(43) Pub. Date: Oct. 12, 2006

(54) Vehicle body mount

(76) Inventors: Martin J. Nilsen, Hampshire, IL (US); Michael E. Ward, Geneva, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/330,545

(22) Filed: Jan. 12, 2006

Related U.S. Application Data
(60) Provisional application No. 60/670,354, filed on Apr. 12, 2005.

(51) Int. Cl. F16B 43/02

(52) U.S. Cl. 411/546

(57) ABSTRACT

A vehicle body mount assembly includes a tube with a first washer axially fixed on the tube at a first end of the tube and a second washer axially fixed on the tube at a second end of the tube. A nut is affixed to the second washer at the second end of the tube.

### CROSS-REFERENCE TO RELATED APPLICATIONS

The present regular U.S. Patent Application claims the benefits of U.S. Provisional application Ser. No. 60/670,354 filed Apr. 12, 2005.

### FIELD OF THE INVENTION

The present invention relates generally to body mount assemblies for vehicles, and more particularly, the present invention relates to shear-style body mount assemblies.

### BACKGROUND OF THE INVENTION

Body mounts are used to fasten a vehicle body to a vehicle frame. Body mounts provide vibration and noise isolation and contribute to improved vehicle ride and handling characteristics. Body mounts are known to include an elongated member extending between mounting holes in the vehicle frame and vehicle body, with an elastomeric element or elements disposed on the elongated member between the vehicle frame and vehicle body.

Shear mounts are known for stabilizing the relative positioning of a vehicle body and a vehicle frame with respect to each other during normal use and during a crash event. Shear mounts are known for use in trucks, sports utility vehicles and the like to isolate the body frame from both vertical movement and lateral movement relative to the frame, to improve both ride and handling characteristics.

A known shear mount assembly includes two concentric tubes of steel around the rubber body mount to help keep the passenger compartment of the vehicle from shifting relative to the frame in the event of a crash. In installation, a bolt extends through a washer at one end, a central tube within the elastomeric body or bodies and a second washer at the opposite end of the tube. A nut engages the bolt and compresses the assembly together. Assembling a vehicle mount as described can be difficult and time consuming, in part because of the numerous individual pieces that must be positioned properly aligned and secured.

Since the tube, washers at each end of the tube and nut are axially fixed relative to each other, it would be advantageous to have a pre-assembly including all the individual components which could be installed as a single assembly between the frame and body, with the bolt inserted thereafter and rotated into the nut. Providing a less expensive design for manufacturing the components would provide further advantages.

### SUMMARY OF THE INVENTION

The present invention provides a vehicle body mount having a tube, first and second washers axially fixed in position on opposite ends of the tube, and a nut affixed at one end of the tube.

In one aspect thereof, the present invention provides a vehicle body mount with a tube having first and second ends. A first washer mechanically engages the first end of the tube in a substantially fixed axial position on the tube. A second washer mechanically engages the second end of the tube in a substantially fixed axial position on the tube. A nut is affixed to the second washer.

In another aspect thereof, the present invention provides a vehicle body mount with a tube having first and second ends, a boss formed in the tube at the first end and a distal end portion of the tube disposed outward from the boss. A first washer is disposed on the tube against the boss. The distal end portion is flared outwardly against the first washer, and the first washer is restrained axially on the tube between the boss and the outwardly flared distal end portion. A second washer is on the second end; and a nut is affixed at the second end.

In a still further aspect thereof, the present invention provides a method for assembling a vehicle body mount with steps of providing a tube having first and second ends, a boss near the first end and a distal end portion outwardly of the boss; providing a first washer, a second washer and a nut; placing the first washer on the tube around the distal end portion flaring the distal end portion outwardly and securing the first washer on the tube axially restrained between the boss and the outwardly flared distal end portion; placing the second washer on the second end in an interference fit relationship holding the second washer in a substantially fixed axial position on the second end; and securing the nut at the second end.

An advantage of the present invention is providing a vehicle body mount which includes a plurality of separate individual pieces assembled together as one unit for installation.

Another advantage of the present invention is providing a tube having washers at each end axially fixed relative to the tube.

Still another advantage of the present invention is providing a tube having a washer and a nut affixed at one end of the tube.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an elevational view of a vehicle body mount in accordance with the present invention;

FIG. 2 is a cross-sectional view of the vehicle body mount shown in FIG. 1, the cross-section having been taken along line 2-2 of FIG. 1;

FIG. 3 is an elevational view of a tube in the body mount, with a washer installed at one end of the tube; and

FIG. 4 is an elevational view of a washer and nut assembly for installation on the exposed end of the tube shown in FIG. 3.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not me regarded as limiting. The use herein “including”, “comprising” and variations thereof is meant to encompass the items and equivalents thereof.

### DETAILED DESCRIPTION OF THE PREFERRED EMBODIMENT

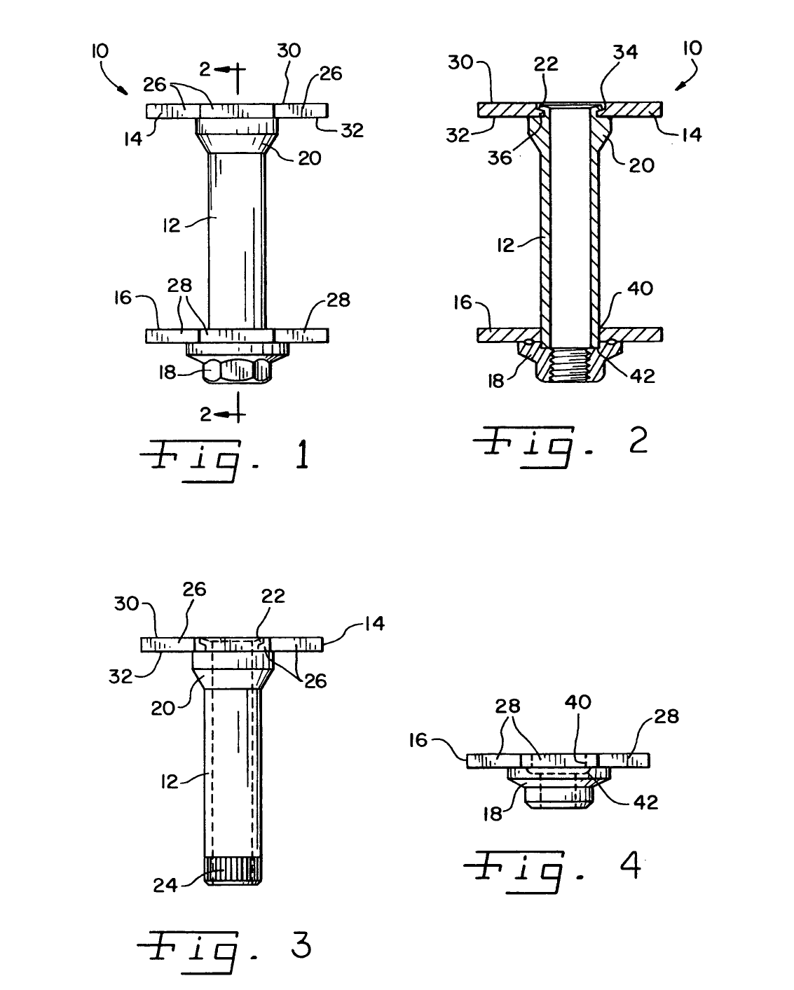

Referring now more specifically to the drawings and to FIG. 1 in particular, a vehicle body mount 10 in accordance with the present invention is shown. Vehicle body mount 10 can be made of steel or other metal suitable for the installation in which it is used, and mount 10 can be made in a variety of sizes, both length and width, as necessary for the vehicle in which is installed.

Body mount assembly 10 includes a tube 12 having first and second ends, with a first washer 14 at the first end and a second washer 16 at the second end. A nut 18 is affixed adjacent second washer 16 at the second end of tube 12.

Tube 12 in the exemplary embodiment shown is an elongated, substantially cylindrical body forming a boss 20 at the first end thereof, with a thin walled distal end portion 22 disposed outwardly of boss 20. Knurls 24 are formed in an outer surface of tube 12 at the second end thereof, opposite boss 20.

First and second washers 14 and 16 in the exemplary embodiment are octagonal structures, each having eight substantially equally sized edge faces 26 and 28, respectively. Three edge faces 26 of first washer 14 are shown in the elevational views of FIGS. 1 and 3, and three edge faces 28 of second washer 16 are shown in the elevational view of FIGS. 1 and 4. However, it should be understood that each washer 14 and 16 includes either substantially equally dimensioned edge faces 26, 28, respectively.

First washer 14 has an outer surface 30 and an inner surface 32. A counter bore 34 is formed in outer surface 30 extending partially into the thickness of first washer 14. Accordingly, a radially inwardly extending lip 36 is formed at the base of counter bore 34. Inner surface 32 and specifically inner lip 36 of first washer 14, is disposed against boss 20 in the assembled structure. Thin wall distal end portion 22 is flared outwardly in counter bore 34, thereby trapping and axially securing lip 36 between boss 20 and outwardly flared distal end portion 22. Accordingly, the axial position of first washer 14 is substantially fixed relative to tube 12, being secured between boss 20 and outwardly flared distal end portion 22.

Second washer 16 defines a central opening 40 of a seize to form an interference fit on tube 12, and specifically to mechanically engage knurls 24 thereof. Accordingly, as second washer 16 is slid onto knurls 24, second washer 16 mechanically engages knurls 24, and the axial position of second washer 16 is substantially fixed relative to tube 12.

Nut 16 forms a nut counter bore 42 of a size to receive the end portion of tube 12 at knurls 24. Accordingly, with knurls 24 inserted into nut 18 the axial position of nut 18 relative to tube 12 is also fixed, with mechanical engagement between knurls 24 and nut counter bore 42. Nut 18 is further fixed relative to second washer 16 by welds 44 which may be a substantially continuous weld or discrete areas of weld. Resistance welding via equally spaced lugs on nut 18 can be used, as those skilled in the art will readily recognize.

Tube 12 can be manufactured by cold forming techniques to include boss 20 and distal end portion 22 at a first end of tube 12, and knurls 24 at the second end of tube 12. Cold forming advantageously increases the strength of tube 12 and forms knurls 24 more efficiently and less expensively than previously known manufacturing techniques using thread rolling for forming knurls. Increased strength from cold forming allows the use of less material and/or lower carbon steels. Material costs are decreased. For still further strengthening, tube 12 can be heat treated or otherwise treated. While cold forming has the advantages noted, other features of the present invention can be realized also by using tube 12 manufactured by other techniques and processes.

First and second washers 14 and 16 are formed from the same material, of the same thickness, and with octagon perimeters. The washers can be formed out of strip metal with significantly less waste than previously known round washers. Accordingly, body mount assembly 10 is manufactured efficiently from the perspectives both of material cost and material usage. While octagon shaped washers are advantageous in terms of material usage and waste reduction, the present invention for body mount 10 can be used advantageously also with conventional round washers of appropriate size.

Tube 12 is formed with distal end portion 22 extending substantially axially from boss 20. During assembly of vehicle body mount 10, first washer 14 is placed over distal end portion 22 while end portion 22 extends substantially axially outwardly relative to boss 20. With first washer 14 disposed against boss 20, thin wall distal end portion 22 is flared outwardly into counter bore 34, as shown in FIG. 2, to trap lip 36 between outwardly flared distal end portion 22 and boss 20. Accordingly, first washer 14 is axially fixed relative to tube 12 without the need for welding or other expensive and time consuming assembly techniques.

Second washer 16 is placed onto knurls 24 in an interference fit relationship, thereby establishing a substantially fixed axial position of second washer 16 relative to tube 12. Nut 18 is urged onto knurls 24 and adjacent second washer 16. The assembly stays together even as resistance welding or other techniques are used to bond nut 18 to second washer 16. Welding of nut 18 to second washer 16 can be performed before assembling nut 18 and second washer 16 on knurls 24, as illustrated in FIG. 4. The completed subassembly of second washer 16 and nut 18 can then be pressed on tube 12 in a single step. The present invention provides improved stiffness at the assembly of second washer 16 and nut 18 on tube 12, with the end of tube 12 being inserted into nut counter bore 42, thereby further reducing the material requirements for vehicle body mount 10.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A vehicle body mount comprising;
a tube having first and second ends;
a first washer mechanically engaging said first end of said tube in a substantially fixed axial position on said tube;
a second washer mechanically engaging said second end of said tube in a substantially fixed axial position on said tube; and
a nut affixed to said second washer.

2. The vehicle body mount of claim 1, one of said first and second ends having knurls on an outer surface of said tube, and one of said first and second washers engaged with said knurls.

3. The vehicle body mount of claim 1, one end of said tube ends defining a boss and a thin wall distal end portion outwardly of said boss.

4. The vehicle body mount of claim 3, said thin wall distal portion being outwardly flared and a portion of one of said washers being restrained between said boss and said outwardly flared distal portion.

5. The vehicle body mount of claim 4, one of said first and second ends having knurls on an outer surface of claim 4, one of said first and second washers engaged with said knurls.

6. The vehicle body mount of claim 4, said first washer having a counter bore opening in a surface thereof and said thin wall distal end portion being outwardly flared in said counter bore.

7. The vehicle body mount of claim 6, one of said first and second ends having knurls on an outer surface of said tube, and one of said first and second washer engaged with said knurls.

8. The vehicle body mount of claim 7, said nut being welded to said second washer.

9. The vehicle body mount of claim 1, said nut defining a nut counter bore and said second end of said tube being disposed in said nut counter bore.

10. The vehicle body mount of claim 9, said second end of said tube having knurls on an outer surface thereof and said second washer engaged on said knurls.

11. The vehicle body mount of claim 9, said nut being welded to said second washer and engaged on said knurls.

12. A vehicle body mount comprising:
a tube having first and second ends;
a boss formed in said tube at said first end;
a distal end portion of said tube disposed outward from said boss;
a first washer disposed on said tube against said boss;
said distal end portion being flared outwardly against said first washer, and said first washer being restrained axially on said tube between said boss and said outwardly flared distal end portion;
a second washer on said second end; and
a nut affixed at said second end.

13. The vehicle body mount of claim 12, said second end having knurls on an outer surface thereof, and said second washer being mechanically engaged against said knurls.

14. The vehicle body mount of claim 13, said nut being welded to said second washer.

15. The vehicle body mount of claim 13, said second end of said tube extending into said nut.

16. The vehicle body mount of claim 15, said nut being welded to said second washer.

17. A method for assembling a vehicle body mount comprising:
providing a tube having first and second ends, a boss near the first end and a distal end portion outwardly of the boss;
providing a first washer, a second washer and a nut;
placing the first washer on the tube around the distal end portion;
flaring the distal end portion outwardly and securing the first washer on the tube axially restrained between the boss and the outwardly flared distal end portion;
placing the second washer on the second end in an interference fit relationship holding the second washer in a substantially fixed axial position on the second end; and
securing the nut at the second end.

18. The method of claim 17, including inserting the second end of the tube into a counter bore of the nut.

19. The method of claim 18, including welding the nut to the second washer.

20. The method of claim 17, including providing a counter bore in the first washer and flaring the distal end portion in to the counter bore.
